(19) United States
(12) Patent Application Publication
(10) Pub. No.: US 2010/0073373 A1
(43) Pub. Date: Mar. 25, 2010

(54) SYSTEM AND METHOD TO MODEL APPLICATION MATURITY

(75) Inventors: John Groff, Peoria, IL (US); Sri Ramanathan, Lutz, FL (US); Judy J. Robb, Chicago, IL (US); James R. Rudd, Charlotte, NC (US); Robert J. Torres, Colleyville, TX (US); Matthew B. Trevathan, Kennesaw, GA (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 12/235,988

(22) Filed: Sep. 23, 2008

(51) Int. Cl. G06T 11/20

(52) U.S. Cl. 345/440

(57) ABSTRACT

A system and method is provided for modeling an application and, more particularly, to a system and method for providing a maturity model of an application (e.g., web 2.0 maturity model). The system is implemented in a computer infrastructure and includes a computer executable code tangibly embodied on a computer readable medium and operable to graphically compare at least a current state of a plurality of technology areas based on a normalized score for each of the plurality of technology areas.

### FIELD OF THE INVENTION

The invention generally relates to a system and method of modeling an application and, more particularly, to a system and method for providing a maturity model of an application (e.g., web 2.0 maturity model).

### BACKGROUND

Technology is a driving force in commerce and business. For example, technology influences content and document management, e-commerce, as well as the general dissemination of information to the masses, to name a few. Technology is also at the cutting edge of new paradigms such as, for example, Internet based advertising and business and social collaboration. In the latter case, Web 2.0 applications have been developed which attempt to enhance creativity, information sharing, and, most notably, collaboration among users. Also, the evolving view of Web 2.0 combines a mixture of portability, collaboration, and technology to improve the user experience. These Web 2.0 applications have led to the evolution of web-based communities such as, for example, social networking sites, wikis and blogs.

As the Internet and other technologies evolve and become an ever more important tool for businesses to increase revenue and reduce costs, many businesses have begun to more seriously assess their use of such technologies. For example, in today's marketplace, retailers and other businesses are looking for ways to increase customer satisfaction, decrease operating cost, and develop a sense of trust between the consumer and the retailer using such technologies. To this end, businesses are developing new models that allow their customers, suppliers, etc., to not only collaborate with the business but also with each other. For example, content and opportunities for collaboration are being provided over managed forums such as, for example, wiki's, blogs, RSS, and folksonomies. Businesses are also able to deliver rich content to users enhancing their experience through an AJAX and flex while moving to portable platforms.

For many companies, they may have the technology to deliver wiki's, blogs, and podcast but they lack a strategy and focus on what, when and how to deliver content to their users. This often indicates that the business has a solid technological foundation, but lacks a business strategy to deliver quality content to its users. For this and other reasons, businesses employ consultants to assess their technology and suggest ways to effectively deploy their technology strategies for monetary or other gains.

In general, technology adoption follows a standard bell curve with a minority of businesses embracing technology in its earlier stages while another minority only reluctantly embrace such technology when it is mature. Said otherwise, a minority of businesses lag behind the technology curve by adopting the technology on the tail end of the bell curve. Of course, the laggards do not gain the same strategic advantage which has been afforded to the early embracing businesses, but do not incur the same costs as implementing infancy technologies as those users that embrace the technology early in its deployment. This cost can often include acceptance, bugs, and total cost to develop. In any event, a majority of companies do not want to pay the cost of early adoption of technology nor do they want to be technological laggard. These businesses usually lie somewhere within the mainstream and fall somewhere in the middle of the technology curve.

Consultants and companies are often looking for quick means to assess where a company lies on the technology curve to help them understand where they are in comparison to their industry as well as market leaders. This helps companies build a road map leveraging their strengths while targeting technologies and business processes that are focused on specific goals. However, this is a difficult task taking into account the pervasiveness of technology, differences on how particular businesses use the technology across an industry, etc.

### SUMMARY

In an aspect of the invention, a system implemented in a computer infrastructure comprises a computer executable code tangibly embodied on a computer readable medium and operable to graphically compare at least a current state of a plurality of technology areas based on a normalized score for each of the plurality of technology areas.

In another aspect of the invention, a system comprises: first program instructions to tally a score attributed to questions and/or comments attributed to a plurality of technology areas; second program instructions to calculate a normalized value for each of the plurality of technology areas; third program instructions to visually represent the normalized value based on the tallied score for each of the plurality of technology areas; a computer readable media which stores the first, second and third program instructions; and a central processing unit to execute the first, second and third program instructions.

In another aspect of the invention, a method provides a maturity model provided on a computer infrastructure. The method comprises presenting questions and/or comments to technology areas; tallying a score associated with the questions and/or comments attributed to the technology areas; calculating a normalized value for each of the technology areas by multiplying a maturity adjustment to the tallied score; and graphically representing the normalized value for each of the technology areas to show an interrelationship thereof.

### BRIEF DESCRIPTION OF SEVERAL VIEWS OF THE DRAWINGS

The present invention is described in the detailed description which follows, in reference to the noted plurality of drawings by way of non-limiting examples of exemplary embodiments of the present invention.

FIG. 1 is an exemplary graphical representation showing a comparison between a current state of certain technology areas in accordance with embodiments of the present invention;

FIG. 2 is an exemplary graphical representation showing a comparison between a current state and an anticipated or future state of certain technology areas in accordance with embodiments of the present invention;

FIG. 3 shows a bell curve graph in accordance with aspects of the invention;

FIG. 4 is an illustrative environment for implementing the steps in accordance with the invention; and

FIG. 5 is a flow diagram showing steps implementing processes in accordance with aspects of the invention.

### DETAILED DESCRIPTION

The invention generally relates to a system and method of modeling an application and, more particularly, to a system and method for providing a maturity model of an application (e.g., web 2.0 maturity model). More specifically, the present invention provides a web 2.0 maturity model, which can depict technology strengths, weaknesses and relationships between certain technologies that are currently in use or will be adopted in the future. As discussed in more detail below, this provides the user with a roadmap of their current state and usage of technology and strategy thereof, as well as how the adoption of technologies and usages will affect business practices, etc.

In embodiments, the present invention focuses on objective benchmarks and technology areas in order to model and/or assess technology strategy, usage and any ensuing gains obtained from such technology, usage and strategy. These technology areas can include, for example, Technology Foundation, Technology Services, Technology Portability, Business Communication, Business Content, Business Commerce, Business Collaboration, Business Syndication and/or Business Portability. In further embodiments, scores (based on questions) are assessed against the usage, strategy, etc. of each of the technology areas based on objective criteria. The scores can then be normalized, in embodiments, to provide an overall score for each of the technology areas. These scores can be visually depicted in a graph or heuristic to show the relationship between each of the technology areas, and to visually show the affect that changes in usage, strategy, etc., may have with relation to such technologies.

Advantageously, the system and method of the present invention allows a user to assess their technology usage and/or strategy in an objective manner, e.g., strengths and weaknesses. The system and method of the present invention also provides a model which graphically depicts how certain adjustments/changes to technology usage will affect their overall technology strategy. This graphical view can be, for example, heuristic view and a more focused radar/spidermap type view of the user's strengths and weaknesses. In additional, the system and method of the present invention provides an objective benchmark to assess technology against other industry participants. In all of these scenarios, and others, it is contemplated that the use of this information will provide the user with the ability to focus their attention on areas of technological adoption that may be needed when building a technology roadmap.

In embodiments, the Maturity Model of the present invention focuses on nine different areas. These different areas are provided for illustrative purposes only, with the understanding that more or less technology areas may be implemented with the present invention. To this end, the present invention contemplates the use of more or less or any combination thereof of the below noted technology areas. The following is a description and related considerations of these different technology areas.

Technology Foundation

Technology Foundation represents a key grouping of technologies that enables a rich Internet experience, standards-based development, and an open architecture that easily allows third-party integration.

Technology Services

Technology Services encapsulates the basic technologies for collaboration and syndication. This may include, for example, wikis, blogging, RSS and podcasts. Clients that have a strong technology services sector, but show weak business syndication and collaboration may need to focus on a strategy for delivering content to users.

Technology Portability

Technology Portability demonstrates mobility and portability. Mobility is the ability to use the solution on various wireless devices. This concept allows the solution to move beyond the desktop to truly a mobile solution. Portability demonstrates an ability of a solution to be able to work autonomously from the web. Most consumers are trending toward mobility with platforms that have a fully functioning, modern browser.

Business Communication

Business Communication demonstrates the ability to communicate to clients, employees, etc. through different modes. For example, business communication may include common contact information such as, for example, telephones, facsimiles, email address, etc.

Business Content

Business Content is the ability to manage documents and content published to the web. This may include a content management and document management system, but its main focus is on a set of processes that are defined to create, review, and publish content. This also focuses on the user's ability to customize and personalize content that is delivered to them. Websites that do not have a content management system or a set of processes that define a user's role in content management often rely heavily on an IT department to publish changes to create content for the web. This creates a duplication in business processes since most content is created by the business not the IT department.

Business Commerce

Business Commerce represents the ability to sell products, goods and services on a website. In its most mature form, e-commerce represents a fully automated process that takes the user through the entire purchasing process in an automated fashion. The commerce section looks at modern friends in e-commerce like ratings and reviews and combines them with e-commerce fundamentals like internal process automation and real-time availability to provide a holistic view of the businesses' e-commerce channel. In most cases, the commerce section is removed from a B2E solution since most companies are not worrying about selling products internally to their employees.

Business Collaboration

Business Collaboration is a broad category defining not only relationships with consumers or users but relationships with third parties. A site that shows a strong collaborative focus exposes services to third parties, creates interactive opportunities such as managed forms to users, and provides other forms of self care and education like podcasts. Business Collaboration is useful for client that have a strong focus on collaboration within their web channel or are looking to leverage a strong sense of community by leveraging the users themselves as experts in answering problems that others may be experiencing.

Business Syndication

Business Syndication is the ability of a business to target and deliver messages via multiple methods that include RSS and atom feeds, podcast, e-mail, blogging, etc. A company that leverages strong business syndication often focuses on delivering targeted education and messages to their clients.

Business Portability

Business Portability demonstrates a businesses need to create portable applications as well as exposing mash ups that leverage a user's location when tailoring content. A mash up is a web application that combines data from more than one source into a single integrated tool, thereby creating a new and distinct web service that was not originally provided by either source.

Those of skill in the art should also realize that there can be some overlap between the technology areas. This is due to the fact that some questions associated with the technology areas may impact multiple categories. As an illustrative and non-limiting example, a company may have technology that allows blogging, but not be focused on the content of the blogging and therefore missing an opportunity for experts within their business to express targeted messages at current and prospective clients. However, these same opportunities could be identified by determining whether the business produces e-mail feeds to their current clients that contain expert information provided by the business. The e-mail feeds could be used to identify a business component that may suit the needs for blogging that in combination with blogging technology could extend their message beyond current customers to prospective customers and other people interested in their opinion.

### EXEMPLARY IMPLEMENTATIONS OF THE PRESENT INVENTION

In embodiments, each of the above technology areas include one or more questions or comment fields related to the usage, strengths, capacities, capabilities, etc. of the technology. For example, some related questions or comment fields for the Technology Foundation area may include whether the site/business, etc.:
1. Exposes services to trusted vendors allowing vendors to mash up their data with your data;
2. Supports rich media architecture like AJAX or Flex;
3. Supports Cascading Style Sheets;
4. Supports collaborative tagging (e.g., folksonomies);
5. Supports REST based Services or other Web Service;
6. Supports the use of JSON (JavaScript Object Notation) as a lightweight data-interchange format; and/or
7. Uses semantically valid XHTML or HTML.

By way of additional examples, different questions or comment fields can be provided for each of the noted technology areas. These questions or comment fields can include the following, by way of non-limiting examples:

Technology Services
1. Supports Content Management;
2. Supports Document Management;
3. Supports customization allowing users the ability to change features on the site;
4. Supports personalization allow the site to deliver tailored content to users;
5. Supports Podcasts;
6. Supports Blogs;
7. Supports RSS Feeds;
8. Supports Managed Forums or wikis; and/or
9. Allows user the ability to control their privacy level.

Technology Portability
1. Supports multiple devices;
2. All Functions are available online (website);
3. Application gains some functionality while being connected to the internet; and/or
4. Application is fully functional on and off the web.

Business Communication
1. Site list common contact information such as, for example, telephone, facsimile, email address, etc.; and/or
2. Email Contact Information.

Business Content
1. Ability to Manage Content (e.g., online brochures, dynamic catalogs);
2. Business supports a content management system that controls content being deployed to the site via a publishing process;
3. Supports user generated support pages;
4. Supports personalization allow the site to deliver tailored content to users; and/or
5. Business leverages document management to control document versioning on their site.

Business Commerce
1. Online Transaction processing;
2. Internal process automation;
3. Real time availability;
4. Advanced product comparison guides;
5. Online procurement and pricing configuration tools;
6. Ability to offer incentives and sales campaigns;
7. Web site supports user generated reviews allowing customers to rate products on the site;
8. Web Site supports collaborative filtering allowing users to know what other people purchased that purchased the same product; and/or
9. Ability to manage up sells and cross sells.

Business Collaboration
1. Site Live Chat/Co-browsing;
2. CSR's and customer have access to the same support data;
3. External Partner Collaboration;
4. Partner Gateways;
5. Supports Webinars & Training;
6. Contextual marketing messaging;
7. Integrated partner offerings;
8. Site supports user generated reviews allowing customers to rate content on the site;
9. Site implements a reputation framework allowing users to build trust with other users by their ratings; and/or
10. Site supports collaborative filtering allowing users to see what content people have viewed similar to what the user has viewed.

Business Community/Syndication
1. Co-branded customer portals;
2. Site uses Business Process Networks allowing partners to look for educational and sales material or collaborate and post new opportunities;
3. Site leverages expert, managed forums where users can post questions and search for answers by trusted users or CSR's;
4. Site strategically uses podcast to deliver messages and educate users;
5. Site strategically uses blogs to deliver messages and educate users;
6. Site strategically uses RSS feeds to communicate to users;
7. Business Supports internal or external innovation networks allowing small groups people to collaborate and innovate without common process barriers; and/or
8. Integration of customer insights to new products/services.

Business Portability
1. Supports multiple devices;
2. All Functions are available online (website);
3. Application gains some functionality while being connected to the internet;
4. Application is fully functional on and off the web; and/or
5. Site leverages a user's location to tailor content.

In any embodiment, each of the technology areas can include a multitude of questions or comments fields which are scored based on objective criteria. A score can be associated with each of these questions or comment fields to determine an overall use and/or strategy state as it relates to the specific technology area. The score can be based on an objective criteria and can be based on a predetermined range. For example, the scores may range from 1 to 5, with 1 being the lowest score and 5 being the highest score. Even more specifically, the following table can be used to determine a score.

| Score | Objective Criteria |
|---|---|
| 5 | Fully Meets (100%) |
| 4 | Substantially Meets (75%) |
| 3 | Partially Meets (50%) |
| 2 | Lightly Meets (25%) |
| 1 | Does Not Meet (0%) |

Those of skill in the art should realize, though, that the scores can be other numerical ranges such as, for example, 1 to 10. Also, the questions that require a simple “no” or “yes” answer may be scored as 1 and 5, respectively (e.g., lowest and highest numerical value).

Once a score is attributed to each of the questions and/or comment fields in a technology area, they are tallied to provide an overall technology area score. It should be understood, though, that it may not be necessary to attribute a score to each question, in which case a value of “0” would be tallied with the remaining scores.

In embodiments, the questions and/or comment fields can be scored based on a current state (or usage) of technology as well as a future or anticipated state (or usage) of the technology. The future or anticipated state of usage may be scored based on a best guess estimate or an actual anticipated usage of the implementation of a technology. The scores for the best guess estimate or an actual anticipated usage of the implementation of a technology can be changed in order to view and/or manipulate different scenarios. In this way, the scores for the future or anticipated state can be compared to each other, or to the current state scores for any combination of the technology areas in order to assess their business value. The comparison can also be used to determine the affect of a change may have on a related technology area, as discussed in greater detail below.

The overall score for the current state (or usage) of a particular technology area as well the future or anticipated state (or usage) of the technology area can be normalized by, for example, taking an average of all of the scores and dividing such value by the tallied score for each individual section. In additional embodiments, the score can be normalized by multiplying the tallied score by a maturity adjustment. The maturity adjustment is the maximum possible overall score for the largest section divided by the maximum possible overall score for the current section, i.e., the section of interest. The maturity adjustment equalizes each section so that they can be seen across a strength chart equally. As such, the normalization of the score makes it easier to make the comparison with any combination of the technology areas as noted above.

By way of one illustrative example using the maturity adjustment, the maturity adjustment of 1.428 can be used for the Technology Foundation area. More specifically, taking the technology area of Business Collaboration as having a possible maximum score of 50, as this technology area has 10 questions with a maximum possible score of 5 for each question (e.g., 10×5=50) and the maximum possible score of the current section of Technology Foundation being 35, as this technology areas has 7 questions with a maximum score of 5 for each question (e.g., 7×5=35), the maturity adjustment would be 50/35 or 1.428. Taking the tallied score for the Technology Foundation area as 17, as an example, the adjusted or normalized score would be 25. This same process can be calculated for each of the technology areas.

It should also be understood that the maturity adjustment (and hence the normalization) can vary depending on, for example, the number of questions or comment fields in the largest section, the highest score that is attributed to each question or comment field and the number of questions or comment fields in the current technology area of interest. Illustratively, the maturity adjustment can be 1.286 for the Technology Foundation area, when the Business Collaboration has having a possible maximum score of 45 and the Technology Foundation has a possible maximum score of 35.

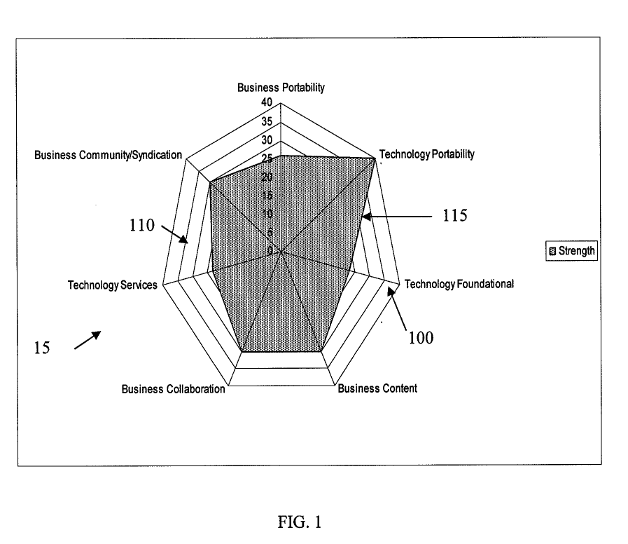

In embodiments, the normalized results can be translated into a graphical representation such as, for example, a spider chart show in FIG. 1. In this graphical representation, the spider chart shows a web designated generally as reference numeral 15. The web 15 includes a plurality of spokes 100, each representing a technology area, e.g., Business Portability, Technology Portability, Technology Foundation, Business Content, Business Collaboration, Technology Services, and Business Community/Syndication. As such, the graphical representation will have an equal number of spokes as there are technology areas. In the illustrative example of FIG. 1, there are eight technology areas and eight respective spokes 100. As discussed above, the present invention contemplates any combination of technology areas.

In the example of FIG. 1, different types of technology areas may be considered depending on a specific application and/or business model. Specifically, B2B and B2C web channels share many of the same characteristics, but there are points of focus that may differ between these models. In the B2C solution, many sites focus on collaboration and syndication. In this case, B2C's often leverage their user base to help solve problems, build a sense of community, and advise potential customers on product offerings. In the case of B2B, the focus may be on smaller collaborative networks between themselves and business partners and a stronger focus on exposing services. In both cases the key points of the graphical representation remain the same but their strengths and weaknesses may differ.

The web 15 includes interlinking portions 110, each representative of an incremental normalized value as discussed above. In this example, there are eight interlinking portions 110, ranging from a value of “0” to “40”. Those of skill in the art should recognize that there can be more or less interlinking portions, depending on the maximum normalized value and the desired increments. Illustratively, there can be 10 interlinking portions, when the maximum normalized value is 50 with increments of 5.

Shaded area 115 represents the composite strengths, e.g., scores, for each technology area and their interrelationships as calculated above. In the example of FIG. 1, the shaded area 115 represents only the scores for the current state of technology areas, e.g., Business Portability, Technology Portability, Technology Foundation, Business Content, Business Collaboration, Technology Services, and Business Community/Syndication. From the graphical representation of FIG. 1, it is possible to discern that the user most likely has many collaborative features on their website that allow third parties to easily integrate into their system. The graphical representation also illustrates quickly that the user can focus on certain areas of technology, e.g., technology services, business portability and business community. And, as shown in FIG. 1, there is a likelihood from the results that the user would need an investment in new technology to develop business community. This is evident in their weakness in technology services.

Although not shown, the web can be completely filled by the shaded area if each technology areas had a perfect score (maximum score); whereas, the shaded area would completely disappear if each technology area had its lowest possible score (minimum area). Also, taking FIG. 1 as an example, it is also possible to view the relationships between any combination of the technology areas by moving any of the technologies areas shown in FIG. 1 to other locations. For example, a relationship can be shown between, e.g., Business Portability and Business Content, by moving the technology areas adjacent to one another.

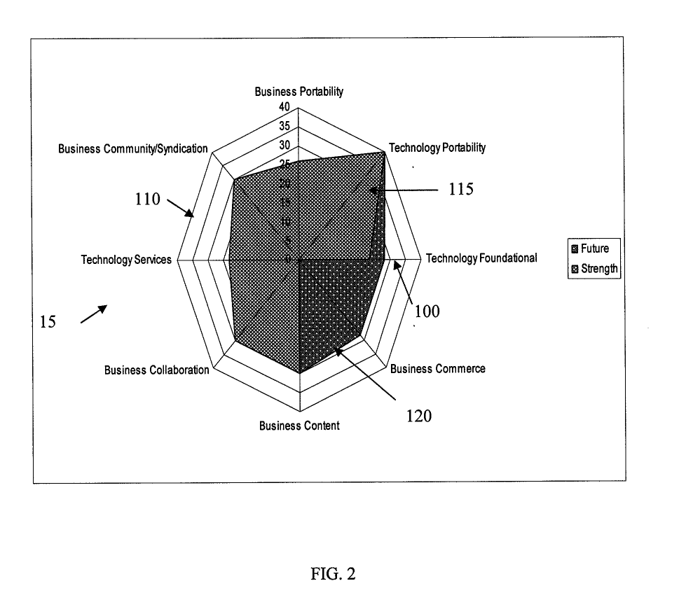

FIG. 2 shows an exemplary graphical representation showing a comparison between the current state and an anticipated or future state of certain technology areas in accordance with embodiments of the present invention. This graphical representation also shows the use of different technology areas and relationships, e.g., Business Portability, Technology Portability, Technology Foundation, Business Content, Business Commerce, Business Collaboration, Technology Services, and Business Community/Syndication. As such, the web 15 includes nine spokes 100, each representing a technology area. The web 15 also includes interlinking portions 110, each representative of an incremental normalized value as discussed above. In this example, there are eight interlinking portions 110, ranging from a value of “0” to “40”.

In the example of FIG. 2, the shaded area 115 represents only the scores for the current state of technology areas. The shaded area 120 represents the composite strengths, e.g., scores, for each of the technology areas and their interrelationships for anticipated or future technology usage and/or strategy. In this example, it is shown that the current state of the technology area of Business Commerce is “0”; whereas, the anticipated or future technology usage and/or strategy of Business Commerce is about 30. As thus shown in this illustrative graphical representation, it is easy to determine the relationships between the different technology areas and current and future or anticipated usage of such by viewing the shaded area 115 and the shaded area 120.

The results shown in FIGS. 1 and 2 can thus be used to assess technology strategy decisions, e.g., strengths and weaknesses. For example, by using the calculations and/or graphical representations discussed herein, it is possible to make educated decisions to modernize certain aspects or areas of technology. Specifically, noting that there is no presence for Business Commerce in the graphical representation of FIG. 2, a user can decide, in view of how it affects other aspects of other technology areas, to make investments in the Business Commerce technology area. By making such infrastructure investments, the user can determine a rate of return on its investments.

Also, using the tool of the invention it is possible to dynamically create the graphical representation while the user completes the inputs for each section. This allows the user to manipulate the graphical representation after questions are answered (scored) to show different possibilities and maturity of a solution. Thus, the graphical representation can then be used to show the current state of the solution and then manipulated to show the future state allowing users the ability to focus on different points of the maturity model while creating a roadmap for improvement, adjustments, etc. in their technology. In this way, the graphical representation creates an easy to understand overview of the strengths and weaknesses of a client solution.

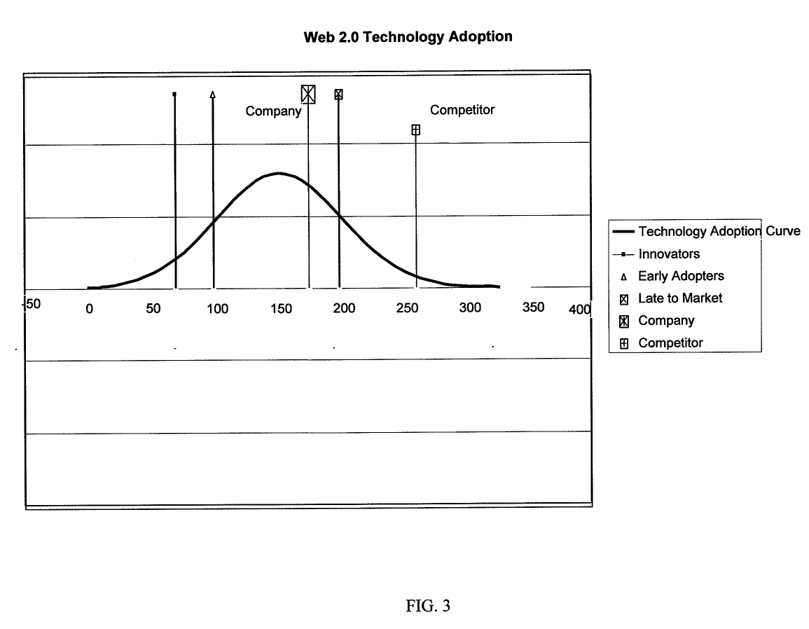

FIG. 3 shows a bell curve graph in accordance with aspects of the invention. This graphical representation shows a comparison between users in a single industry, for example, using the normalized results of the present invention. The x-axis represents the total possible score that a user (e.g., company) can receive on the assessment minus their actual score. The lower the score on the graph represents the level of innovation and risk that a business is willing to take with regard to technology implementation. It also demonstrates the level of adoption of Web 2.0 innovations that the user has made from both a business and technology's perspective.

For example, by using the values calculated in accordance with the present invention, it is possible to plot one or more competitors' technology adoptions on a bell curve for a specific industry. This allows a user to compare technology adoption against other players in the same industry to determine whether they are on the forefront of the technological curve, in the majority or laggards in implementing certain technologies. As noted in the example of FIG. 3, it is easy to see that the company's competitor is a laggard to the market while the company being primarily profiled is at the tail end of mainstream adoption. These results can then be used to determine the business value of making adjustments, changes or overhauls, etc. to one or more technologies.

### Exemplary System Environment, Infrastructure, Processes and System Architecture

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CDROM),
an optical storage device,
a transmission media such as those supporting the Internet or an intranet, or a magnetic storage device.

The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

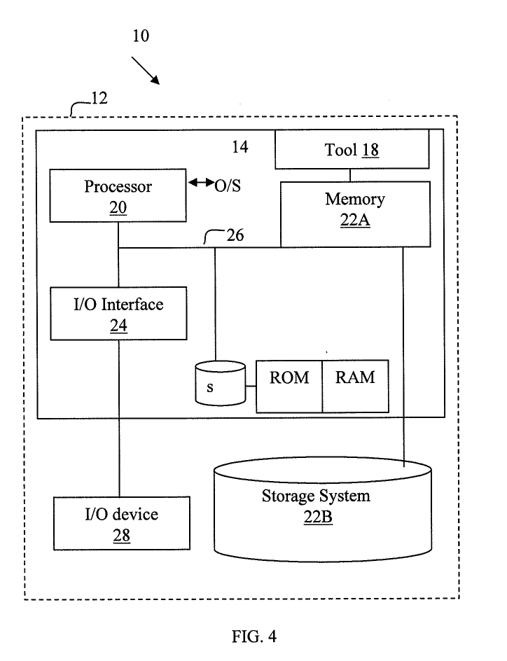

FIG. 4 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 includes a Tool (module or program code) 18 configured to make the computing device 14 operable to perform the services described herein. The Tool 18 can be implemented as one or more program code stored in memory 22A as separate or combined modules. For example, the Tool 18 has the ability to provide questions to the user in order to gain insight into the strengths and weaknesses of the user's technology use and/or strategy. Although the questionnaire may be the same for different business models, e.g., B2E, B2C, and B2B, the Tool 18 also provide the ability to exclude any technology area which, in turn, would be excluded from the graphical representations shown in FIGS. 1 and 2. This allows users to gain a better perspective of their technology, e.g., intranets, and how they are providing learning, collaborative and other tools to their employees, clients, suppliers, etc.

By using the Tool 18, businesses can focus on different technology areas, e.g., business community, technology services, and business content, and benefit by determining which technology areas to strengthen, e.g., exposing services such as an employee telephone directory via a REST based web service internally allowing employees to create custom mash ups with their own data therefore providing new services. This provides the user with the ability to quickly view a website and use the output to help provide a high-level roadmap of possibilities to pursue in specific technology areas. In addition, the Tool 18 provides users with the ability to rate content, goods and services or view other users ratings of such services based on the reviewer's reputation. The Tool 18 also provides users with the insight on how they compare to competitors within their industry as well as businesses outside their industry.

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and a CPU.

The computing device 14 is in communication with the external I/O device/resource 28 and the storage system 22B. For example, the I/O device 28 can comprise any device that enables an individual to interact with the computing device 14 or any device that enables the computing device 14 to communicate with one or more other computing devices using any type of communications link. The external I/O device/resource 28 may be for example, a handheld device, PDA, handset, keyboard etc. In particular, the I/O device 28 may be used to display questions to a user, allow a user to input a score attribute to the question, and display visual representations (service) in accordance with the invention such as, for example, graphical representations shown in FIGS. 1-3.

In general, the processor 20 executes computer program code, which can be stored in the memory 22A and/or storage system 22B. While executing the computer program code, the processor 20 can read and/or write data to/from memory 22A, storage system 22B, and/or I/O interface 24. The program code executes the processes of the invention. The storage system 22B may store specific questions and scores attributable to the specific questions, as well as any graphical representations generated by the Tool 18. The bus 26 provides a communications link between each of the components in the computing device 14.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the server 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

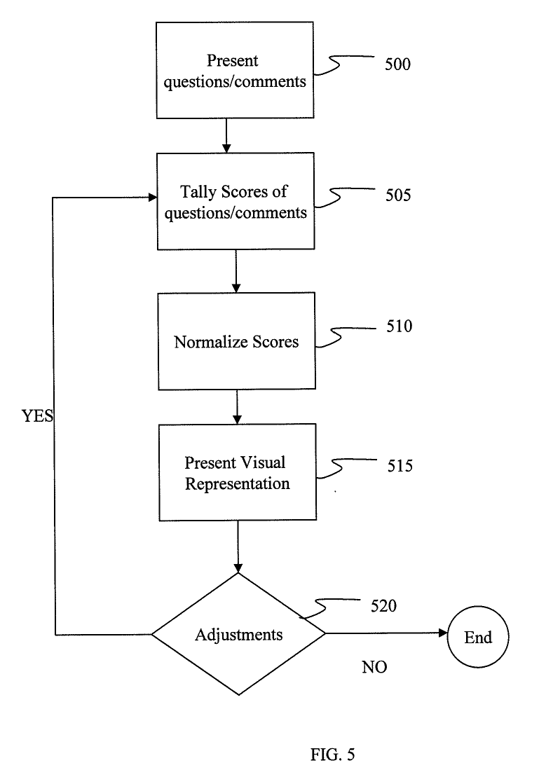

FIG. 5 is a flow diagram showing steps implementing processes in accordance with aspects of the invention. The steps of the invention may be implemented on the computer infrastructure of FIG. 4, for example. The flowcharts and/or block diagrams in the Figure illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. Each block of the flowcharts, and combinations of the flowchart illustrations can be implemented by special purpose hardware-based systems that perform the specified functions or acts, or combinations of special purpose hardware and computer instructions and/or software, as described above.

More specifically, at step 500, a plurality of questions and/or comment fields are presented to a user. Each of the questions and/or comment fields may be associated with a technology area. At step 505, a score associated with each of the questions and/or comment fields, for each technology area, is tallied to provide a total score for each of the technology areas. The score for can be for a current state of technology or a future or anticipated state of technology. At step 510, the score for each technology area is normalized. This can be accomplished, for example, by multiplying the tallied score by an adjustment factor, e.g., maturity adjustment. At step 515, the results are visually displayed such as, for example, shown in any of FIGS. 1-3. At step 520, a determination is made as to whether any of the scores are adjusted. If not, then the process ends. If there is an adjustment, then the process continues at step 505.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A system implemented in a computer infrastructure comprising computer executable code tangibly embodied on a computer readable medium and being operable to graphically compare at least a current state of a plurality of technology areas based on a normalized score for each of the plurality of technology areas.

2. The system of claim 1, wherein the computer executable code is operable to periodically update the current state of the plurality of technology areas based on a non-normalized score attributed to at least one of comments and questions related to any of the plurality of technology areas.

3. The system of claim 1, wherein the computer executable code is operable to manipulate a graphical representation based on inputs of a user relating to the plurality of technology areas.

4. The system of claim 3, wherein the graphical representation is a spider chart showing a comparison and interrelationship between two or more of the plurality of technology areas.

5. The system of claim 4, wherein the computer executable code is operable to manipulate the interrelationship between the two or more of the plurality of technology areas by moving a desired plurality of technology areas to another adjacent of the plurality of technology areas.

6. The system of claim 1, wherein the computer executable code is operable to graphically compare the current state of the plurality of technology areas with a future state of the plurality of technology areas based on a normalized score for each of the current and future states associated with the plurality of technology areas.

7. The system of claim 6, wherein the current state of the plurality of technology areas and the future state of the plurality of technology areas overlap.

8. The system of claim 1, wherein the computer executable code is operable to calculate the normalized score by multiplying a tallied score attributed separately to each of the plurality of technology areas to a maturity adjustment.

9. The system of claim 8, wherein the computer executable code is operable to calculate the maturity adjustment by determining a maximum possible overall score for a largest section of the plurality of technology areas and dividing by a maximum possible overall score for a current section of the plurality of technology areas.

10. The system of claim 9, wherein the maturity adjustment equalizes each section of the plurality of technology areas so that the each section can be represented across a strength chart.

11. The system of claim 1, wherein the computer executable code is at least one of maintained, deployed, created and supported on a computing infrastructure by a service provider.

12. A computer program product, comprising:
first program instructions to tally a score attributed to questions and/or comments attributed to a plurality of technology areas;
second program instructions to calculate a normalized value for each of the plurality of technology areas;
third program instructions to visually represent the normalized value based on the tallied score for each of the plurality of technology areas;
a computer readable media which stores the first, second and third program instructions; and
a central processing unit to execute the first, second and third program instructions.

13. The computer program product of claim 12, wherein the first, second and third program instructions are at least one of maintained, deployed, created and supported by a service provider.

14. The computer program product of claim 12, further comprising fourth program instructions to display a plurality of the questions and/or comments attributed to the plurality of technology areas.

15. The computer program product of claim 12, wherein the second program instructions calculate the normalized value by multiplying a tallied score attributed to each of the plurality of technology areas to a maturity adjustment.

16. The computer program product of claim 15, wherein the second program instructions calculate the maturity adjustment by determining a maximum possible overall score for a largest section of the plurality of technology areas and dividing by a maximum possible overall score for a current section of the plurality of technology areas.

17. The computer program product of claim 16, wherein the maturity adjustment equalizes each section of the plurality of technology areas so that the each section can be represented across a strength chart.

18. The computer program product of claim 12, wherein the third program instructions visually represents the normalized value for each of the plurality of technology areas in a spider chart which shows a comparison and interrelationship between two or more of the plurality of technology areas.

19. The computer program product of claim 18, wherein the third program instructions manipulate the visual representation by showing different interrelationship between the two or more of the plurality of technology areas by moving a desired one of the plurality of technology areas to another adjacent of the plurality of technology areas.

20. The computer program product of claim 12, wherein the second program instructions calculate the normalized value of a current state of technology and a future state of technology, and the third program instructions overlays the normalized value of the current state of technology and the future state of technology on a spider graph which can be dynamically changed based on the tallied score attributed to the questions and/or comments attributed to the plurality of technology areas.

21. A method for providing a maturity model provided on a computer infrastructure, comprising:
presenting questions and/or comments to technology areas;
tallying a score associated with the questions and/or comments attributed to the technology areas;
calculating a normalized value for each of the technology areas by multiplying a maturity adjustment to the tallied score; and
graphically representing the normalized value for each of the technology areas to show an interrelationship thereof.

22. The method of claim 21, wherein the steps of claim 21 are performed on hardware and software on the computing infrastructure.

23. The method of claim 21, further comprising adjusting the graphically represented normalized value for any of the technology areas when the tallied score is manipulated.

24. The method of claim 21, wherein the tallied score is for a future or anticipated technology state.
